(19) United States
(12) Patent Application Publication
(10) Pub. No.: US 2014/0052734 A1
(43) Pub. Date: Feb. 20, 2014

(54) COMPUTING DEVICE AND METHOD FOR CREATING DATA INDEXES FOR BIG DATA

(71) Applicant: HON HAI PRECISION INDUSTRY CO., LTD., New Taipei (TW)

(72) Inventors: CHUNG-I LEE, New Taipei (TW); CHIEN-FA YEH, New Taipei (TW); CHENG-FENG TSAI, New Taipei (TW); GEN-CHI LU, New Taipei (TW)

(73) Assignee: HON HAI PRECISION INDUSTRY CO., LTD., New Taipei (TW)

(21) Appl. No.: 13/961,892

(22) Filed: Aug. 8, 2013

(30) Foreign Application Priority Data
Aug. 15, 2012 (TW) 101129451

(51) Int. Cl. G06F 17/30

(52) U.S. Cl. CPC G06F 17/30312
USPC 707/741

(57) ABSTRACT

In a method for creating data indexes for big data of a computing device, data lists are obtained from a data pool in a storage device, and a priority is set for each of the data lists. Data queues are created in the storage device, and the data lists are assigned to the data queues according to the set priorities. A node index is created for each data list stored in each of the data queues, and the data lists are deleted from the data queue after the node indexes creation. The method obtains a data list having a highest priority from the data pool if such a data list needs to be processed first, combines the node indexes to generate a root index for the data pool, and stores the root index of the data pool and the node indexes of the data lists in the storage device.

### BACKGROUND

1. Technical Field

Embodiments of the present disclosure relate to data index creating systems and methods, and particularly to a computing device and a method for creating data indexes for big data of the computing device.

2. Description of Related Art

Along with the rapid development of the computing industry, dealing with or searching massive amounts of data (hereinafter “big data”) quickly has become difficult for users. Current file systems need to frequently search, update and delete the big data existing in physical memory of a computer system. Obviously, data indexes for the big data will greatly affect the speed of the computer system. The file systems use the data indexes to organize the big data which have been helpful in managing the big data. However, a key challenge is how to create data indexes for the big data in the file systems. Therefore, there is room for improvement in the art.

### BRIEF DESCRIPTION OF THE DRAWINGS

FIG. 1 is a block diagram of one embodiment of a computing device including a data index creating system.

FIG. 2 is a flowchart of one embodiment of a method of creating data indexes for big data of the computing device of FIG. 1.

FIG. 3 is illustrates one exemplary embodiment of creating node indexes and a root index for the big data in a data pool.

FIG. 4 illustrates one exemplary embodiment of processing a priority of each data list in the data pool.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In the present disclosure, the word “module,” as used herein, refers to logic embodied in hardware or firmware, or to a collection of software instructions, written in a program language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of a non-transitory computer-readable medium include CDs, DVDs, flash memory, and hard disk drives.

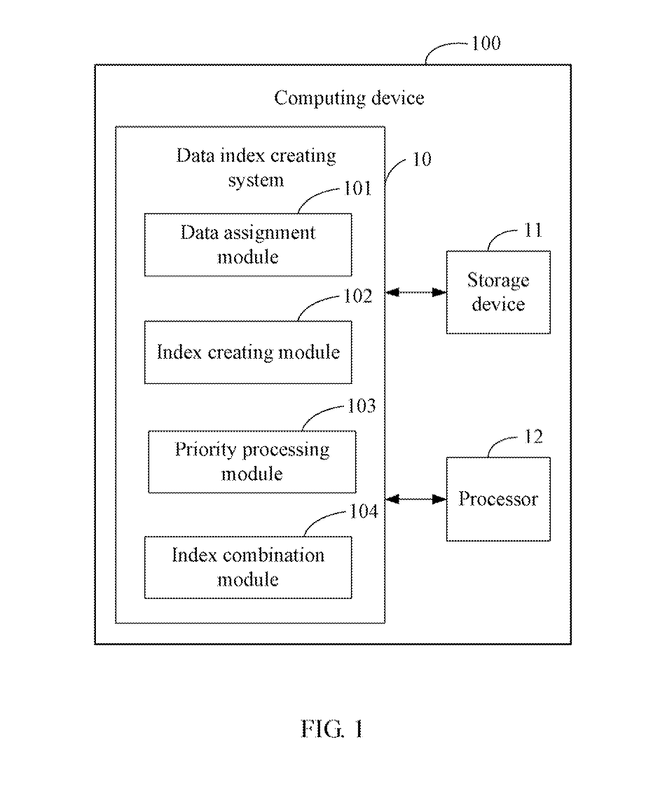

FIG. 1 is a block diagram of one embodiment of a computing device 100 including a data index creating system 10. In the embodiment, the data index creating system 10 is implemented by the computing device 100, and dynamically creates a plurality of data indexes for massive amounts of data (hereinafter referred to as “big data”) according to resources of the computing device 100. The big data may include text files, image files, and multimedia data files including audio data and video data. In one embodiment, the computing device 100 may be a personal computer (PC), a server or any other data processing device.

The computing device 100 further includes, but is not limited to, a storage device 11 and at least one processor 12. In one embodiment, the storage device 11 may be an internal storage system, such as a random access memory (RAM) for temporary storage of information, and/or a read only memory (ROM) for permanent storage of information. The storage device 11 may also be an external storage system, such as an external hard disk, a storage card, network access storage (NAS), or a data storage medium. The at least one processor 12 is a central processing unit (CPU) or microprocessor that performs various functions of the computing device 100.

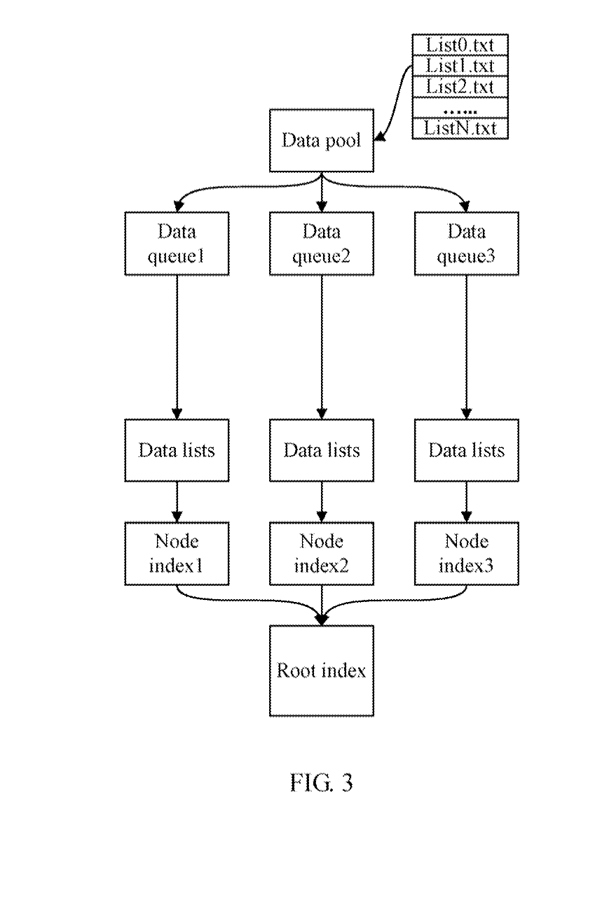

The storage device 11 includes a data pool that stores the big data and a plurality of data queues for storing temporary data lists. The data pool includes a plurality of data lists, such as List0.txt, List1.txt, List2.txt, . . . , and ListN.text as shown in FIG. 3. Each of the data lists stores a type of datum which has a data identifier for identifying the datum. The data identifier can be denoted as a sequence number, such as Sa101, Sa102, . . . , and Sa101, Sa10n, for example.

In one embodiment, the data index creating system 10 includes a data assignment module 101, an index creating module 102, a priority processing module 103, and an index combination module 104. The modules 101-104 may comprise computerized instructions in the form of one or more programs that are stored in the storage device 11 and executed by the at least one processor 12. A description of each module is given in the following paragraphs.

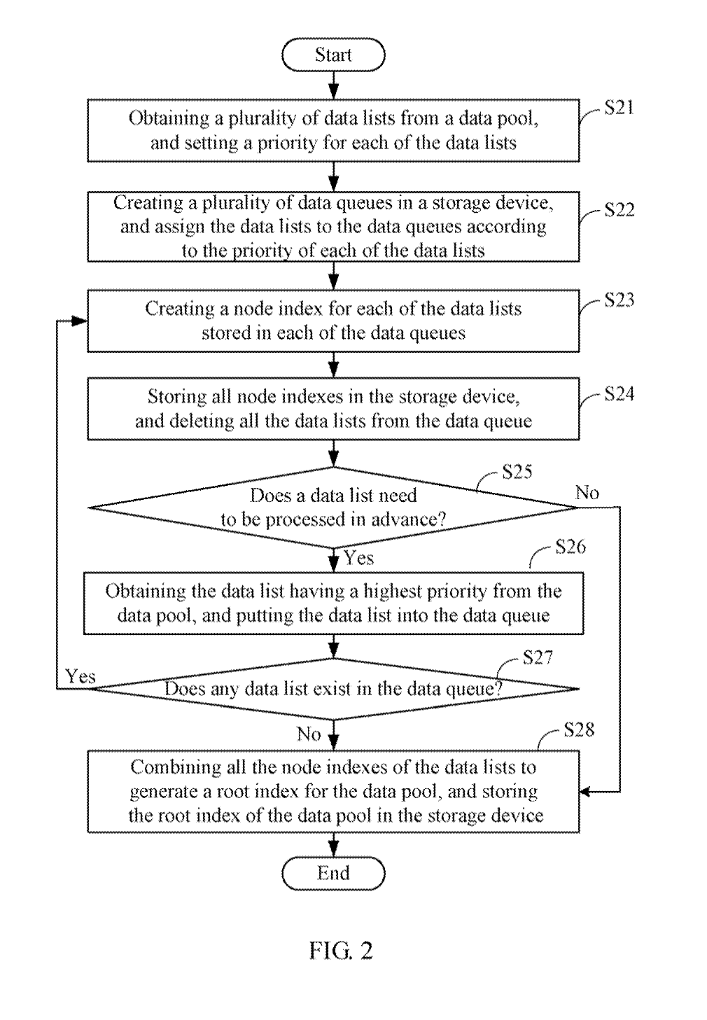

FIG. 2 is a flowchart of one embodiment of a method for creating data indexes for big data of the computing device 100 of FIG. 1. The method is performed by execution of computer-readable program codes or instructions by the at least one processor 12 of the computing device 100. The method dynamically creates a plurality of data indexes for the big data according to resources of the computing device 100. Depending on the embodiment, additional steps may be added, others removed, and the ordering of the steps may be changed.

In step S21, the data assignment module 101 obtains a plurality of data lists from the data pool stored in the storage device 11, and sets a priority for each of the data lists according to user requirements. In one embodiment, the data assignment module 101 sets a priority of a data list that needs to be processed in advance as the highest priority, and sets priorities of other data lists in the data pool in sequence according to a name of each of the data lists. Referring to FIG. 3, n numbers of data lists named List0.text, List1.text, List2.txt, . . . , and ListN.txt are obtained from the data pool. If the data list named List0.txt including data needs to be processed first, the data assignment module 101 sets a highest priority for the data list named List0.txt, and sets lower priorities for every other data lists in sequence according to the names of the other data lists.

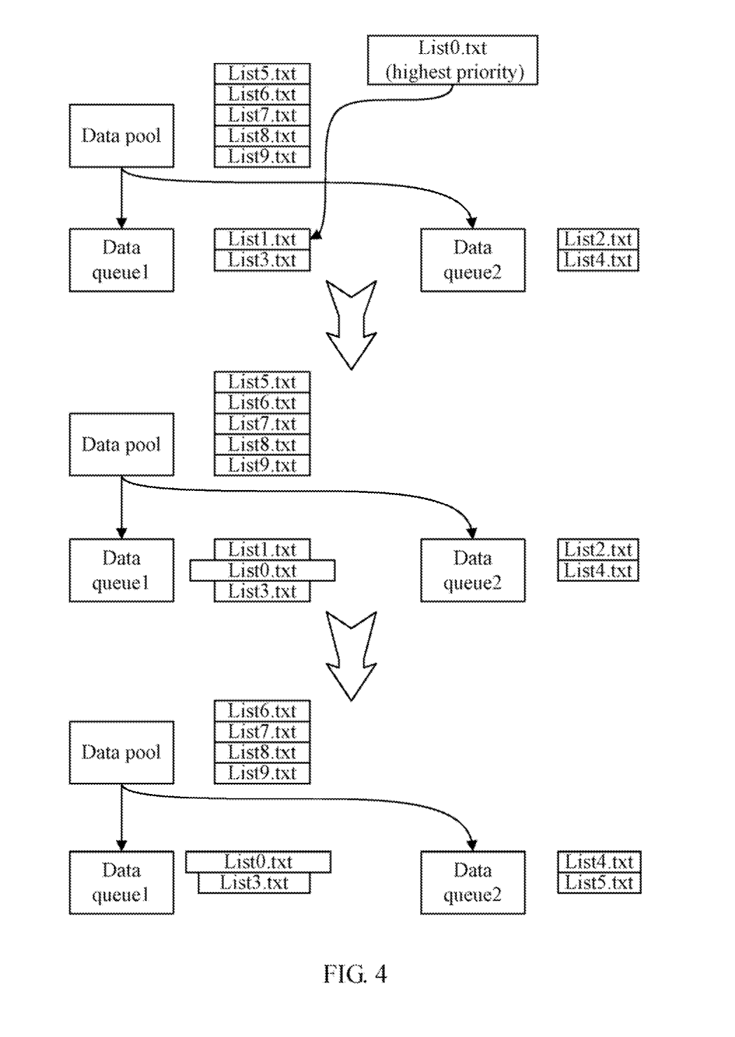

In step S22, the data assignment module 101 creates a plurality of data queues in the storage device 11, and assigns the data lists to the data queues according to the priority of each of the data lists. Referring to FIG. 4, the data assignment module 101 creates two data queues (e.g., Data queue1 and Data queue2) in the storage device 11. The Data queue1 stores the data lists named List1.txt and List2.txt, and the Data queue2 stores the data lists named List3.txt and List4.txt.

In step S23, the index creating module 102 creates a node index for each of the data lists that are stored in each of the data queues. Referring to FIG. 3, three data queues (e.g., Data queue1, Data queue2 and Data queue3) are created in the storage device 11, and each of the data queues stores one or more data lists. The index creating module 102 creates a node index1 for the data lists of Data queue1, creates a node index2 for the data lists of Data queue2, and creates a node index3 for the data lists of Data queue3.

In step S24, the index creating module 102 stores all node indexes of the data lists in the storage device 11, and deletes the data lists from the corresponding data queue. Referring to FIG. 4, if the node index of the data list named List1.txt in Data queue1 has been created, the index creating module 102 deletes the data list named List1.txt from Data queue1, so as not to needlessly copy data, and release more storage space of the storage device 11 for storing other data lists.

In step S25, the priority processing module 103 determines whether a data list of the data pool needs to be processed in advance by checking the data list which has a highest priority. In the embodiment, if a data list has a highest priority, the priority processing module 103 determines that such a data list needs to be processed in advance, and step S26 is implemented. Otherwise, if no data list needs to be processed in advance, step S28 is implemented.

In step S26, the priority processing module 103 obtains the data list having a highest priority from the data pool, and puts the data list into a free data queue to be processed. Referring to FIG. 4, where the data list named List0 has a higher priority than other data lists, the priority processing module 103 obtains List0 from the data pool, and puts List0 before the data list named List3 into Data queue1, so that List0 can be processed prior to List3.

In step S27, the index combination module 104 checks whether any data list exists in the data queue to be processed. If any data list exists in the data queue to be processed, the process goes back to step S23. Otherwise, if no data list in the data queue needs to be processed, step S28 is implemented.

In step S28, the index combination module 104 combines all the node indexes of the data lists to generate a root index for the data pool, and stores all the node indexes of the data lists and the root index of the data pool in the storage device 11. As shown in FIG. 3, the index combination module 104 generates a root index for the data pool by combining Node index1 of the data lists in Data queue1, Node index2 of the data lists in Data queue2, and Node index3 of the data lists in Data queue3, and then stores the root index, Node index1, Node index2 and Node index3 into the storage device 11.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device, comprising:
at least one processor; and
a storage device storing one or more computer-readable program instructions, which when executed by the at least one processor, causes the at least one processor to:
obtain a plurality of data lists from a data pool stored in the storage device, and set a priority for each of the data lists;
create a plurality of data queues in the storage device, and assign the data lists to the data queues according to the priority of each of the data lists;
create a node index for each data list stored in each of the data queues;
store all node indexes of the data lists in the storage device, and delete the data lists from the corresponding data queue; and
combine all the node indexes of the data lists to generate a root index for the data pool, and store the root index of the data pool in the storage device.

2. The computing device according to claim 1, wherein the program instructions further cause the at least one processor to:
determine whether a data list of the data pool needs to be processed in advance;
obtain the data list having a highest priority from the data pool and put the data list into a free data queue to be processed, if the data list needs to be processed in advance;
determine whether any data list of the data pool needs to create the node index; and
create a node index for the data list if any data list exists in the data queue.

3. The computing device according to claim 1, wherein setting a priority for each of the data lists comprises:
setting a priority of a data list that needs to be processed in advance as the highest priority; and
setting priorities of other data lists in the data pool according to a name of each of the data lists.

4. The computing device according to claim 1, wherein the data pool includes a plurality of data lists, and each of the data lists stores a type of datum which has a data identifier for identifying the datum.

5. The computing device according to claim 1, wherein the storage device is a hard disk or a network access storage (NAS) for storing the data pool that stores big data and a plurality data queues for temporarily the data lists.

6. The computing device according to claim 5, wherein the big data are text files, image files, or multimedia data files including audio data and video data.

7. A method for creating data indexes for big data of a computing device, the method comprising:
obtaining a plurality of data lists from a data pool stored in a storage device of the computing device, and setting a priority for each of the data lists;
creating a plurality of data queues in the storage device, and assigning the data lists to the data queues according to the priority of each of the data lists;
creating a node index for each data list stored in each of the data queues;
storing all node indexes of the data lists in the storage device, and deleting the data lists from the corresponding data queue; and
combining all the node indexes of the data lists to generate a root index for the data pool, and storing the root index of the data pool in the storage device.

8. The method according to claim 7, further comprising:
determining whether a data list of the data pool needs to be processed in advance;
obtaining the data list having a highest priority from the data pool and putting the data list into a free data queue to be processed, if the data list needs to be processed in advance;
determining whether any data list exists in the data queue; and
creating a node index for the data list if any data list exists in the data queue.

9. The method according to claim 7, wherein the step of setting a priority for each of the data lists comprises:
setting a priority of a data list that needs to be processed in advance as the highest priority; and
setting priorities of other data lists in the data pool according to a name of each of the data lists.

10. The method according to claim 7, wherein the data pool includes a plurality of data lists, and each of the data lists stores a type of datum which has a data identifier for identifying the datum.

11. The method according to claim 7, wherein the storage device is a hard disk or a network access storage (NAS) for storing the data pool that stores the big data and a plurality data queues for temporarily the data lists.

12. The method according to claim 7, wherein the big data are text files, image files, or multimedia data files including audio data and video data.

13. A non-transitory storage medium having stored thereon instructions that, when executed by at least one processor of a computing device, cause the processor to perform a method for creating data indexes for big data of the computing device, the method comprising:
obtaining a plurality of data lists from a data pool stored in a storage device of the computing device, and setting a priority for each of the data lists;
creating a plurality of data queues in the storage device, and assigning the data lists to the data queues according to the priority of each of the data lists;
creating a node index for each data list stored in each of the data queues;
storing all node indexes of the data lists in the storage device, and deleting the data lists from the corresponding data queue; and
combining all the node indexes of the data lists to generate a root index for the data pool, and storing the root index of the data pool in the storage device.

14. The storage medium according to claim 13, wherein the method further comprises:
determining whether a data list of the data pool needs to be processed in advance;
obtaining the data list having a highest priority from the data pool and putting the data list into a free data queue to be processed, if the data list needs to be processed in advance;
determining whether any data list exists in the data queue; and
creating a node index for the data list if any data list exists in the data queue.

15. The storage medium according to claim 13, wherein the step of setting a priority for each of the data lists comprises:
setting a priority of a data list that needs to be processed in advance as the highest priority; and
setting priorities of other data lists in the data pool according to a name of each of the data lists.

16. The storage medium according to claim 13, wherein the data pool includes a plurality of data lists, and each of the data lists stores a type of datum which has a data identifier for identifying the datum.

17. The storage medium according to claim 13, wherein the storage device is a hard disk or a network access storage (NAS) for storing the data pool that stores the big data and a plurality data queues for temporarily storing the data lists.

18. The storage medium according to claim 13, wherein the big data are text files, image files, or multimedia data files including audio data and video data.
